(19) United States
(12) Patent Application Publication
(10) Pub. No.: US 2002/0074405 A1
(43) Pub. Date: Jun. 20, 2002

(54) Method of reading barcode and barcode reading system

(76) Inventors: Eiichi Hadano, Ashigarashimogun (JP); Tateyuki Sugimoto, Odawara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/522,978

(22) Filed: Mar. 10, 2000

(30) Foreign Application Priority Data
Jul. 27, 1999 (JP) 11-211726

(51) Int. Cl. G06K 5/04; G06K 7/10; G06K 9/32

(52) U.S. Cl. 235/462.08

(57) ABSTRACT

The extraction of barcode area and the recognition of barcodes are enabled with input sheets, on which multiple barcodes of multiple specifications are printed at different positions or in different directions, or with each sheet, on which barcodes of different specifications are printed at different positions or in different directions. The barcode recognition system of the present invention is provided with a barcode area extracting means that decides the image of barcode with the two dimensional pixel distribution and extracts the barcode area, a means of deciding the similarity of barcode stripes that confirms that the image inside the barcode area is barcode with the two dimensional distribution of pixel and infers barcode specification, a barcode recognizing means that recognizes barcodes with multiple barcode specifications, and a recognized result deciding means that narrows down the barcode specifications based on recognition result with multiple barcode specifications.

### BACKGROUND OF THE INVENTION

The present invention relates generally to barcode recognition and, in particular, to the auto extraction and reading of barcode areas of multiple specifications.

Conventionally, in reading of barcode areas by an Optical Character Recognition (OCR) unit, the position of barcode area and the barcode type given in a barcode specification are assigned in advance. The assigned area is read with the assigned specification. The reading is typically used with the horizontal barcode. In this case, only the input sheet with the fixed position of the barcode and its associated barcode specification can be read. Other barcodes including those in the vertical direction (a rotation 90 degrees) and horizontal barcodes with a rotation of 180 degrees cannot be read, using the above technique.

A barcode recognition unit that automatically extracts and reads a barcode area is disclosed in Japanese unexamined patent publication JP 09-022437. This barcode recognition unit reads “0” and “1” (pixel data that is, for example, “0” for a white pattern and “1,” for a black pattern) of a pixel of each line and finds a position where the pattern matches a “01010” pattern that is a center bar of the Japan Article Numbering (JAN) at the area where the interval of “01” transition is not more than the predetermined slice value. If the position cannot be found, it will be looked for on the pixels of the next line. If the center bar is found, a start bar and an end bar that are a “101 ”pattern of the same interval is sought. In case a start bar, a center bar and an end bar are found, character codes are decoded. This publication discloses that it can recognize typically JAN standard and shorten codes. There are several limitations. First, the positioning is made by looking for “01” patterns of pixels on a line, therefore, when there is a noise pattern on a line which happens to agree with the pattern of the start bar, the center bar or the end bar, an erroneous-extraction can be made and second, only barcodes arranged in the horizontal direction can be recognized.

Japanese unexamined patent publication JP 10-198755 discloses a barcode recognition unit that converts an input image to a binary image and using a mask decision circuit determines an alternation pattern By applying the pattern to the binary image and grouping the places where the pattern matches, the size of the area is decided. The collected areas become a barcode area. From the distances between the center of gravity of each area in the barcode area and a regression line, it is determined whether it is an authentic component of a barcode, and if not, than the barcode is rejected. If accepted, the barcode in the barcode area is decoded. This publication is for separating and extracting postal management barcodes. Thus, the limitation of this disclosure is that extraction of the position and recognition of the barcode is based on a single specification.

Globally, today there are many different “standard” barcode specifications including ITF (interleaved 2 of 5), NW7, Code 39, Code 128, JAN, UPC and the like. ITF is standardized as JIS-X-0502, NW7 is standardized as JIS-X-503 and JAN is standardized as JIS-X-0501. These specifications differ by the kinds of characters, the size of bar (width, length and the ratio between a thick element and a thin element) and the number of digits Several of these different barcodes could be on an input sheet in different positions and directions.

As seen by the above-mentioned barcode reader units of the prior art, the features of a barcode of a specific specification and an identified barcode area are required for recognition. Thus, there is a need for a barcode reader unit that can recognize barcodes of different specifications which may be printed at different positions or in different directions depending on input sheets.

### SUMMARY OF THE INVENTION

The present invention provides a method and system for the extraction of a barcode area and the recognition of barcodes including multiple barcodes of multiple specifications which are printed at different positions or in different directions on an input sheets and that the barcodes of different specifications are printed at different positions or in different directions on each input sheet.

In an exemplary embodiment a barcode recognition method of, the present invention is provided in which barcode area is first extracted which may, for example, include extracting a connected component. Next, a decision function on the similarity of barcode stripes is performed that confirms that the barcode area contains a barcode and that infers a barcode specification(s). Barcode recognition is done, when a barcode specification cannot be inferred or when a barcode area has multiple inferred barcode specifications based on barcodes in some or all barcode specifications. Lastly, a recognition result decision selects one specification of the above multiple specifications in the barcode area based on the recognition results. Further, in an alternative embodiment, barcodes of different specifications which are printed at different positions or in different directions on an input sheet(s), may be extracted and recognized.

Another embodiment provides a method of recognizing a barcode belonging to one of a plurality of specifications, where initially which specification the barcode belongs to is not known. An image including a barcode is inputted and the barcode area which includes the barcode is extracted using connected components, e.g., 4-connected or 8-connected components. Next feature extraction is performed which may include using a frequency distribution of barcode bar widths in the barcode area. The features are used to determine which specification the barcode belongs to and the barcode is then decoded using the specification.

Another specific embodiment provides a barcode reading system. The system includes an image input unit that inputs sheets having multiple barcodes as binary coded image; a barcode area extraction unit that extracts each barcode area from said multiple barcodes of said binary coded image; a barcode recognition unit that transfers said barcodes of said multiple barcode areas to code data recognizing them with multiple barcode specifications; and a recognition result decision unit that decides the correctness of transfer to code data as the result of recognition by said barcode recognition unit.

The above embodiment may also include in the barcode area extraction unit, a means that extracts a connected component from said binary coded image; a means that decides the ratio between the height and the width of said connected component is not less than the predetermined value and the width is not more than the predetermined value; and a means that decides the distances between said multiple connected components are not more than the predetermined length, and a means that extracts area of said multiple connected components as a barcode area when the distances between said multiple connected components, of which ratio between the height and the width is not less than the predetermined value and the width is not more than the predetermined value.

### BRIEF DESCRIPTION OF THE DRAWINGS

FIG. 1 is a simplified block diagram of the barcode recognition process of a specific embodiment of the present invention.

FIG. 2 is a diagram that illustrates barcode area extraction processing by the decision of a connected component according to an embodiment of the present invention.

FIG. 3 is a diagram that shows barcode area extraction processing in the horizontal direction by the result of cut-in side shifting for start and end point according to an embodiment of the present invention.

FIG. 4 is a diagram that shows barcode area extraction processing in vertical direction by the result of cut-in side shifting for start and end point according to an embodiment of the present invention.

FIG. 5 is a diagram that illustrates the processing for the decision of the similarity of bar stripe by the width of bar stripe according to an embodiment of the present invention.

FIG. 6 is a diagram that illustrates the processing for the decision of the similarity of bar stripe in the condition of bar baseline according to an embodiment of the present invention.

FIG. 7 is a diagram that illustrates the processing for the decision of the similarity of bar stripe by readable characters according to an embodiment of the present invention.

FIG. 8 is a diagram that illustrates the processing for the decision of the similarity of bar stripe by the number of barcode stripes according to an embodiment of the present invention.

FIG. 9 is a diagram that illustrates barcode recognition processing according to an embodiment of the present invention.

FIG. 10 is a diagram that illustrates the processing of the decision of recognition result according to an embodiment of the present invention.

FIG. 11 is a diagram that illustrates the read processing of barcode with marks inside a barcode area according to an embodiment of the present invention.

FIG. 12 is a diagram that illustrates the system structure of an embodiment of the present invention.

FIG. 13 is a diagram that illustrates the read system structure of an embodiment of the present invention.

FIG. 14 is a diagram that illustrates the flow of reading by an embodiment of the present invention.

FIG. 15 is a block diagram that illustrates barcode read processing by a alternative embodiment of the present invention.

FIG. 16 is a block diagram that illustrates the processing for barcode recognition and decision of recognition result by a alternative embodiment of the present invention.

### DESCRIPTION OF THE SPECIFIC EMBODIMENTS

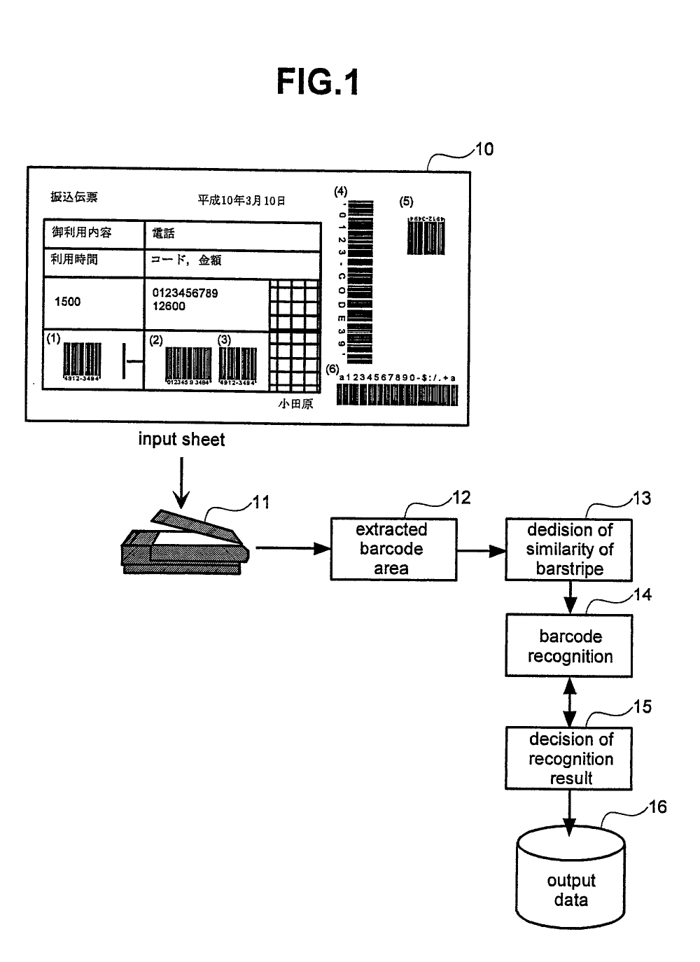

FIG. 1 shows a simplified block diagram of the barcode recognition process of a specific embodiment of the present invention. In this embodiment, input sheets 10 are barcode sheets to be read. Barcode area extraction 12 is performed with the images of the input sheets 10 that are input from an image scanner 11. In the barcode area extraction 12, the barcode areas are extracted from multiple barcodes of multiple specifications that are printed at different positions on each input sheet, and/or barcode input sheets that are printed in different directions. In the decision of the similarity of barstripes 13, an index is set that indicates that an extracted barcode area includes a barcode, and the inference of barcode specification by pinpointing a specific barcode specification is performed. In barcode recognition 14, barcode recognition in a barcode area is performed based on the levels of the similarity of barcode stripes and the inference of barcode specification. The barcode recognition is performed with all barcode specifications that are supported by the barcode recognition when result of the decision of the similarity of barcode stripes is not definite (though a barcode is detected, the specification of it cannot be pinpointed). When the result of the decision of the similarity of barcode stripes can only be narrowed down to several specifications, barcodes are decoded with the several specifications. In the decision of recognition result 15, a readable result is selected from recognition results with multiple specifications by barcode recognition. The selected results are output to an output data 16.

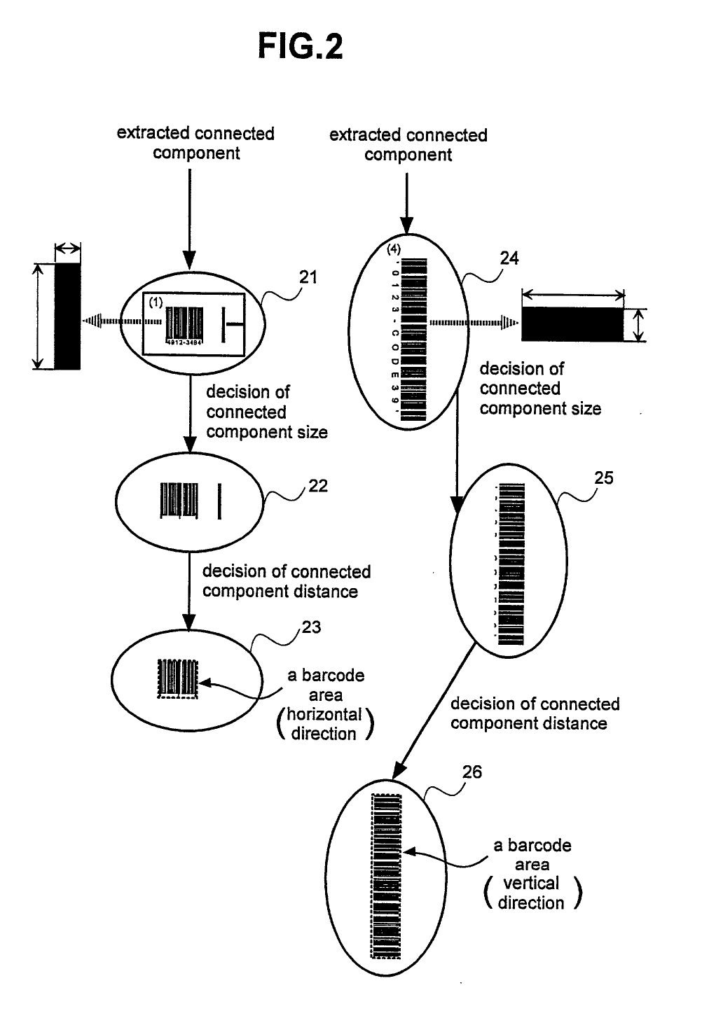

FIG. 2 is a diagram that shows the processing of barcode area extraction by the decision of a connected component in the barcode area extraction 12 in a specific embodiment. The connected component is a pattern comprised of consecutive black dots. In a specific embodiment they may include 4 and/or 8 connected regions as known to those of ordinary skill in the art. An example of extracting barcodes that are printed in horizontal direction at (1) on the input sheets 10 is explained. For the explanation of this case, only the area around the barcode of (1) is described. At first, a connected component 21 of an input sheet is extracted. Then a portrait connected component 22 is obtained by the decision of a connected component size. In the decision of a connected component size, a portrait connected component is extracted. A portrait connected component has a connected component having a ratio between the height and the width of not less than A: 1 and the width that is not more than B mm. In this case, as the barcodes are printed in a horizontal direction, the height is a size in the vertical direction and the width is a size in the horizontal direction. A barcode area 23 in the horizontal direction is obtained by deciding the distances between connected components in relation to the portrait connected component 22. In deciding the distances between connected components, the distances between portrait connected components that are not longer than C mm are extracted.

FIG. 2 also shows an example of the extraction of barcode area that is vertically printed. In this case, vertical barcode of (4) is described as a sample for explanation. Connected component 24 of an input sheet is extracted. A landscape connected component 25 is obtained by the decision of a connected component size. The landscape connected component is a connected component that has the ratio between the height and the width of not less than D: 1 and the width of not more than E mm. In this case, as the barcodes are printed in the vertical direction, and the height is a size in the horizontal direction and the width is a size in vertical direction. By deciding the distances between connected components in relation to the landscape connected components 25, a barcode area 26 in the vertical direction is decided. In deciding the distances between connected components, the distances between landscape connected components of not longer than F mm are extracted. In a specific embodiment of the present invention, A and D are 5, which are ratios between the height and the width, B and E are 1.5, and C and F are 1.5.

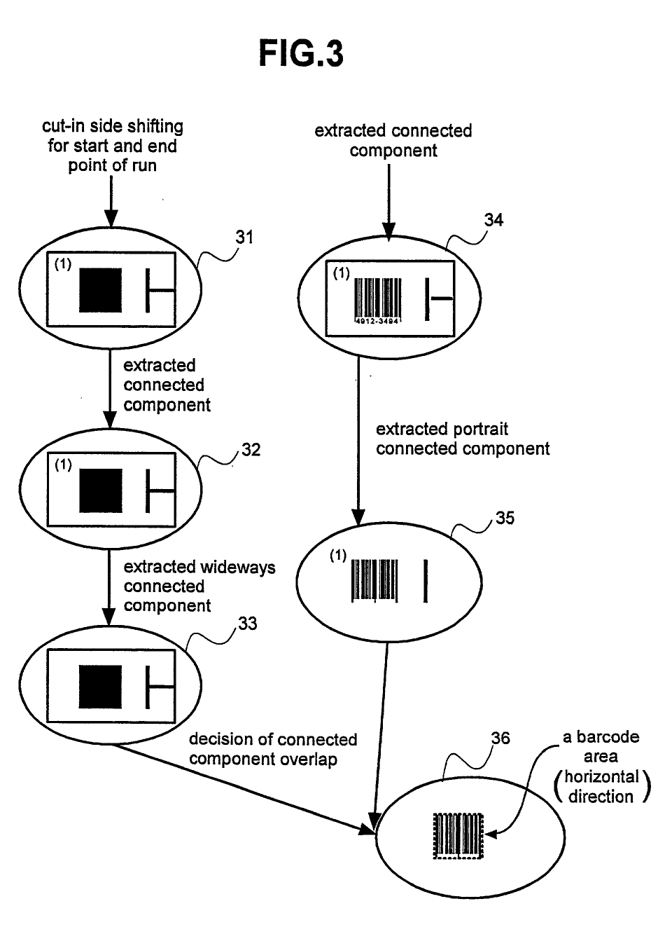

FIG. 3 is a diagram that illustrates the processing of extraction of a barcode area of horizontal barcodes with cut-in side shifting for start and stop point result in extracted barcode area 12. An example of the extraction of horizontally printed barcode that is at location (1) on input sheets 10 is explained. In this case, as the example of description, the area around the barcodes of location (1) is mentioned. First, cut-in side shifting for start and end point result 31 is performed; that is cut-in side shifting of image data pattern of input sheets to wider and then to narrower in horizontal direction is extracted. Next, a connected component 32 of an input sheet is extracted by connected component extraction from cut-in side shifting for start and end point result 31. Then a portrait connected component 33 is decided by a portrait connected component extraction. In addition, a connected component 34 of the input sheet is extracted from the input sheets 10 by connected component extraction. Then, a portrait connected component 35 is extracted by portrait connected component extraction. A portrait connected component is extracted by portrait connected component extraction. A portrait connected component is a connected component having the ratio between the height and the width of no less than G:1 and the width of no more than H mm. In a specific embodiment of the present invention, G is 5, which is the ratio between the height and the width and H is 1.5. By the decision of connected component overlap, based on a landscape connected component 33 and a portrait connected component 35, an area having both of them is sought. As the result of it, a horizontal barcode area 36 is extracted.

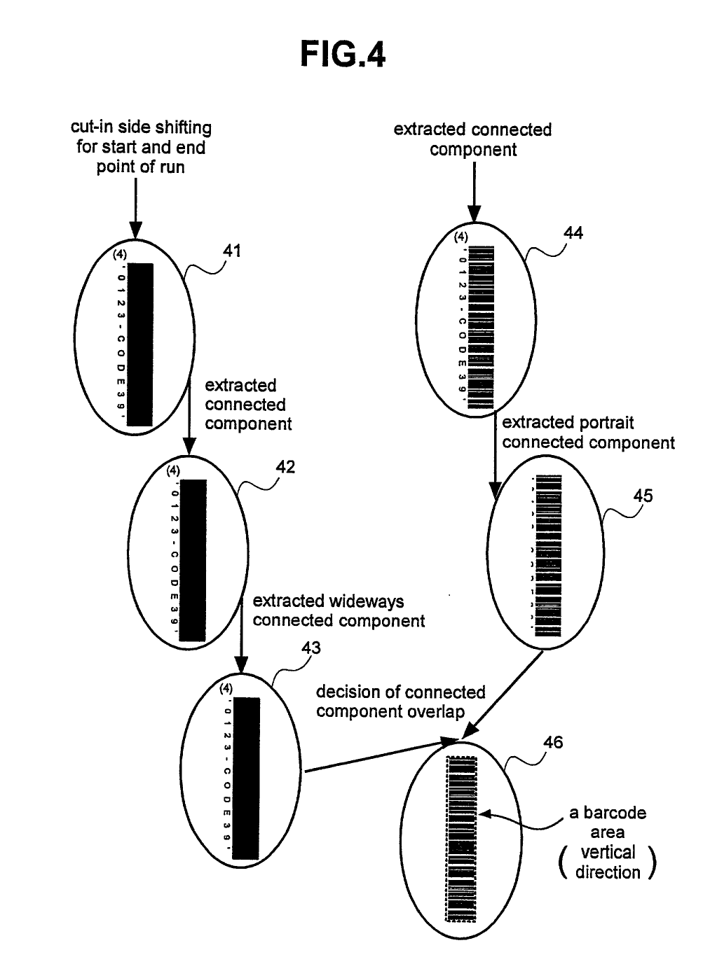

FIG. 4 is a diagram that illustrates the processing of extracting barcode area of vertical barcodes by the cut-in side shifting for start and end point result in extracted barcode area 12. An example of extraction of barcodes printed in vertical direction at location (4) on the input sheets 10 is explained. In this case, as the example of description, around the barcode of location (4) is mentioned. First, cut-in side shifting for start and end point result 41, after shifting the pattern of the input sheets to wider and then narrower in the vertical direction, is extracted. Next, a connected component 42 of the input sheets is extracted from cut-in side shifting for start and end point result 41 by connected component extraction. Then, by portrait connected component extraction, portrait connected component 43 is obtained. On the other hand, a connected component 44 of the input sheets is extracted from the input sheets 10 by connected component extraction. Then, by landscape connected component extraction, a landscape connected component 45 is extracted. The ratio between the height and the width of the landscape connected component is not less than 1:1 and the width of a landscape connected component is not more than J mm. In this embodiment of the present invention, the height is a horizontal size and the width is a vertical size, as the barcodes are printed in a vertical direction. For example, I is 5, which is the ratio between the height and the width and J is 1.5. By the decision of connected component overlap, an area where the both of a portrait connected component 43 and a landscape connected component 45 exist is decided based on both of them. As the result of it, a vertical direction barcode area 46 is extracted.

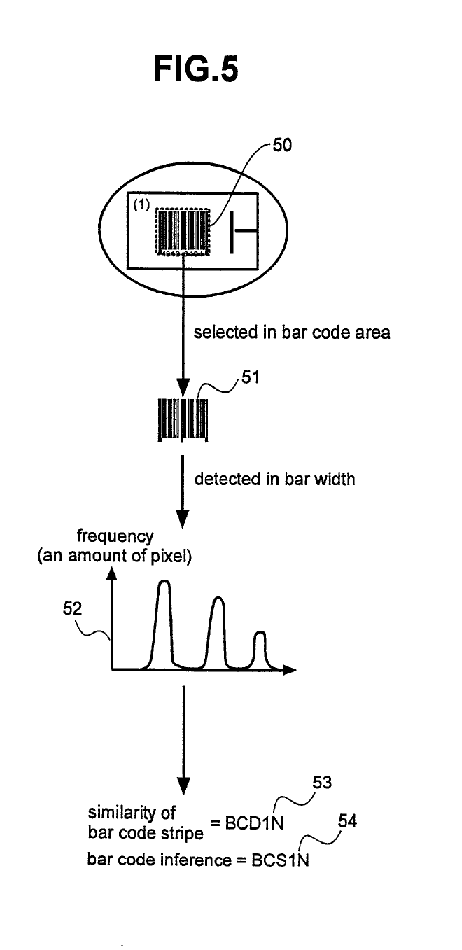

FIG. 5 is a diagram that illustrates the processing of decision of the similarity of barcode stripes 13 that decides the similarity of barcode stripes with bar width. A method to decide the similarity of barcode stripes is explained with the barcode image that is extracted as a barcode area. Here, it is explained with an example of barcode area 50 at location (1) that is extracted by barcode area extraction. Next, the condition of bar width 52 is determined with barcode 51. For the condition of bar width 52, the frequency of a detected bar width is determined by detecting the width of the bar component on all lines inside the barcode area. The similarity of barcode stripes is decided based on the condition of bar width 52. If the frequency is not less than the height of barcode area (number of lines)×K, it is judged to be there exists the maximum value of the frequency. For example, in case the maximum value of the frequency is judged to exist with the frequency of not less than the twice of the number of lines, K=2 is obtained. When the total of the frequency of the condition of bar width within the range of ±N1 dots from the centering value of the bar width, where the maximum value of the frequency of the condition of bar width exists, is not less than N2% of the total frequencies, the similarity of barcode stripe BCD1N=25%×“coefficient” is output. The coefficient is a weighted coefficient based on the levels of importance among the processing of the similarity of barcode stripes including others. In the inference of barcode specification, when the maximum value of the frequency of the condition of bar width appears twice, the specification will be the specification with only wide bars and narrow bars as with Code 39, NW7, Interleaved 2 of 5, ITF, Code 128, etc. If the maximum value of the frequency appears not less than three times, the specification will be with bars, of which width is 1, 2, 3 and 4 times of a unit bar as with JAN, UPC, etc. According to these results, inferred barcode BCS1N 54 is output. In an alternative embodiment, the condition of bar width 52 graph has an X-axis, giving each bar width (e.g., there are three barwidths in FIG. 5) and a Y-axis giving the number of lines at each bar width.

The value of each symbol in a specific embodiment is as follows:

N1=2×(input image dpi+200)

However, when the input image is not more than 200 dpi, the “input image dpi+200” is considered to be 1.

N2=80

The value decided as a maximum value=height of barcode area (number of lines)×K. BCD1N=25%×coefficient.

BCS1N=code specification flag

Where the code specification flag includes one or more bits with a bit representing: JAN(standard), JAN (shortened), Code 39, NWT, Interleaved 2 of 5, ITF, Code 128 and UPC.”

The above mentioned values are examples of default values and other values can be set by evaluating input sheets to be read.

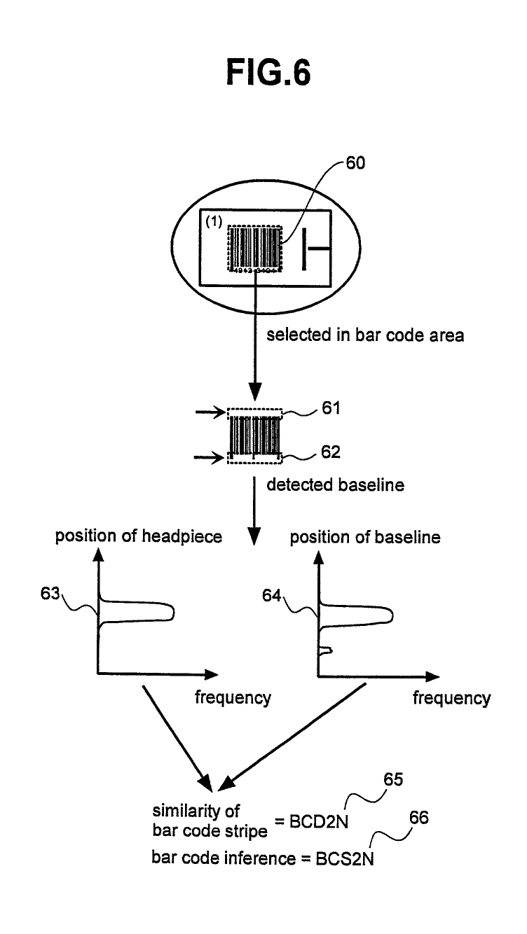

FIG. 6 is a diagram that illustrates the processing the decision of similarity of barcode stripes 13 that decides the similarity of barcode stripes with baseline bar. It is described with the example of barcode area 60 at location (1) extracted by the processing of extracting barcode area. First, an upper side baseline component 61 that indicates an upper side position of each bar and a lower side baseline component 62 that indicates a lower side position of each bar are sought in the barcode area. The conditions of bar baseline 63 and 64 are acquired by detecting the position of an upper side (start y coordinates) of a bar from the upper side baseline component 61 and the position of a lower side (end y coordinates) from the lower side baseline component 62. The condition of bar baseline is acquired as the frequency on y-coordinates that has an axis of a bar upper side regarding to the bar upper side and as the frequency on y-coordinates that has an axis of bar lower side regarding to the bar lower side. The similarity of barcode stripes is decided based on these conditions of bar base lines 63 and 64. In case that the total of the frequencies that are obtained within the range of ±N11 dots from the coordinates of the maximum value of the frequency in the conditions of bar baselines 63 and 64 are not less than N21% of all the frequencies, the similarity of barcode stripes BCD2N=25%×coefficient is output. The coefficient is a weighted coefficient that is decided by the level of importance considering other processing of deciding the similarity of barcode stripes. In inferring barcode specification, when the maximum value of the frequency of the condition of bar baseline is one at an upper side and two at a lower side, the specification is a specification having the bars of different length as with JAN, UPC, etc. With this result, inferred barcode BCS2N 66 is output. The value of each symbol is as follows.

N11=2×(input image dpi+200)

However, when the input image is not more than 200 dpi, the “input image dpi+200” is considered to be 1.

N21=80

BCD2N=25%×coefficient

BCS2N=code specification flag

Above mentioned values are example default values and other values can be set by evaluating input sheets to be read.

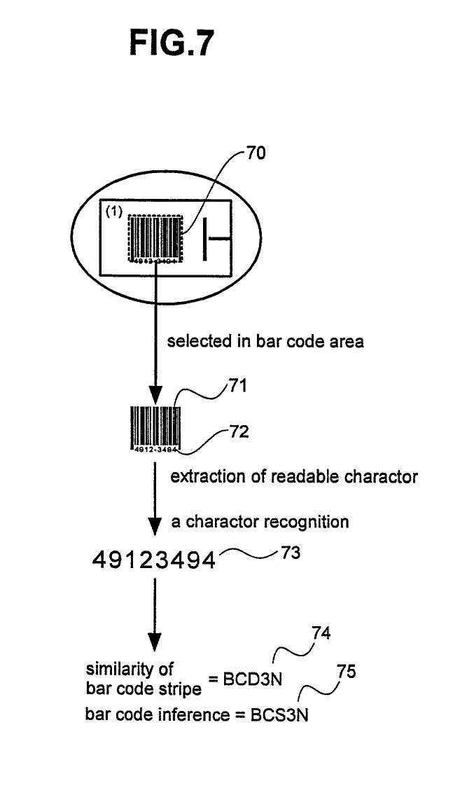

FIG. 7 is a diagram that illustrates the processing of decision of similarity of barcode stripes 13 that decides the similarity of barcode stripes with readable characters of the bar. It is described with the example of a bar code area 70 at location (1) that is extracted by the process of extracting bar code area. First, an upper side 71 or a lower side area 72 in a barcode area is examined. Here readable character area 72, of which character size ratio (width: height) is H1:1 to H2:1, is acquired. Character recognizing the components inside the readable character area, recognition result 73 is obtained. The similarity of barcode stripes is decided by the recognition result 74. When the readable characters exist at the upper side or the lower side of the barcode area, the similarity of barcode stripes BCD3N=25%×coefficient is output. The coefficient is a weighted coefficient that is decided by the level of importance considering other processing of deciding the similarity of barcode stripes. In inferring barcode specification, when a first and a last characters are alphabetic, and when between characters are numeric, the specification will be NW7. In case that a first and a last characters are symbols of * and in between characters are numeric, alphabetic and symbols or mixture of two or three kinds of numeric, alphabetic and symbols, the specification will be Code 39. If the characters are only numeric, the specification will be one of JAN, UPC, Interleaved 2 of 5 and ITF. In case that a first and a last characters are alphabetic and in between characters are alphabetic, numeric and symbols, the specification will be Code 128. As the result, barcode inference BCS3N 74 is output. The value of each symbol is as follows;

H1=0.3

H2=1.2

BCD3N=25%×coefficient

BCS3N=code specification flag

Above mentioned values are example default values and other values can be set evaluating the input sheets to be read.

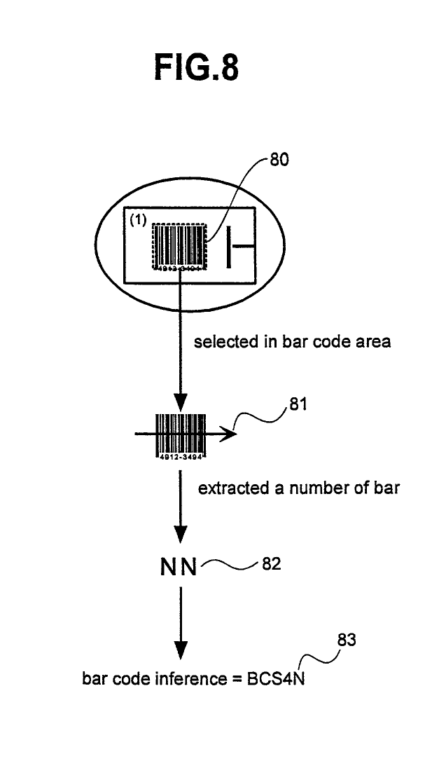

FIG. 8 is a diagram that illustrates the processing of decision of similarity of barcode stripes 13 that decides the similarity of barcode stripes with the number of bars. It is explained with the example of a barcode area 80 at location (1) that is extracted by the processing of barcode area extraction. First, the number of black bars inside the barcode area is sought in seeking direction 81 and the number of bars is extracted. As the result, number of bars NN 82 is obtained. When the number is 30, the specification may be either JAN (standard) or UPC. If the number is 22, the specification may be JAN (shortened). In case the number can be divided by 5, the specification may be one of Code 39, Interleaved 2 of 5 and ITF. In case the number can be divided by 4, the specification may be NW7. In case the number can be divided by 3, the specification may be Code 39. As the result, barcode inference BC54N 83 is output.

Although FIG. 5, FIG. 6, FIG. 7 and FIG. 8 describe the decision of similarity of barcode stripes 13 in the horizontal direction, the result can be applied to the decision of the similarity of barcode stripes in vertical direction by rotating the content by 90 degrees.

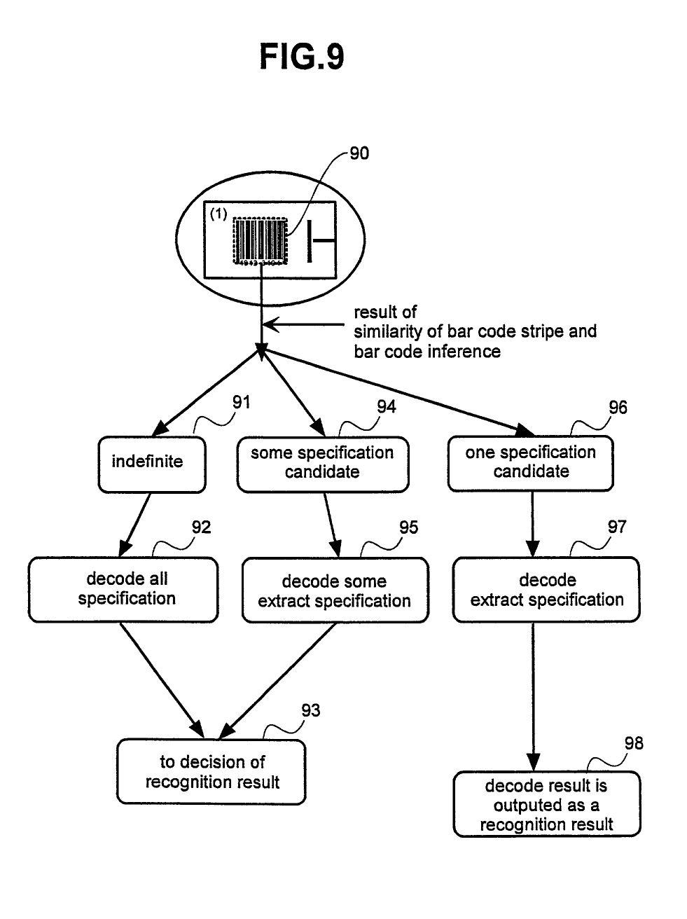

FIG. 9 is a diagram that illustrates the processing of barcode recognition 14. At 90, regarding the barcode that is the object of recognition, the result of the similarity of barcode stripes and barcode inference of FIG. 5 to FIG. 8 is processed.

Practically, when the total of the similarity of barcode stripes by the processing of decision of the similarity of barcode stripes of FIG. 5 to FIG. 8 is not less than 50% and the result of barcode inference is not definite (not pin pointed), it will be processed with indefinite 91. In this case, the data are decoded with all specifications and the each decoded result is transferred to the decision of recognition result 93.

When the total of the similarity of barcode stripes by the processing of decision of the similarity of barcode stripes of FIG. 5 to FIG. 8 is not less than 50% and the result of barcode inference is multiple but narrowed down (not all of the specifications are activated with the code specification flag but more than one specification is activated), it will be processed with some specification candidates 94. In this case, as there are multiple candidates of specification, the data are decoded with the inferred multiple specifications and each decoded result is transferred to the decision of recognition result 93.

In decoding the data with narrowed down multiple specifications, the multiple specifications can be given with a priority sequence. The priority sequence can be decided based on the result of barcode inference of the processing of the decision of the similarity of barcode stripes. Namely, based on code specification flag that is output by the processing of the decision of the similarity of barcode stripes of FIG. 5 to FIG. 8, X point is given to each processing of the decision of the similarity of barcode stripes. In case the flag is activated to predetermined coefficient XK in each decision of the similarity of barcode stripes, X is 1, and in case the flag is not activated, 0 is multiplied to X. The total sum of points together with the points after the decision of the similarity barcode stripes is the points for each barcode specification. If the points are the same, the priority can be given to a specification activated with the flag at the designated processing out of the processing of FIG. 5 to FIG. 8 based on the content set in user information or to a specification that is standardized as JIS.

For example, in the decision of the similarity of barcode stripes of FIG. 5, the number of maximum values is 3. In FIG. 6, the number of maximum value is 1 at the upper side and 2 at the lower side. In FIG. 7, characters are numeric. In FIG. 8, number of bars in the barcode is multiple of 5. In the barcode such as described above, JAN (standard) is 4 points, JAN (shortened) is 3 points, UPC is 3 points, ITF is 2 points, Interleaved 2 of 5 is 2 points and Code 39 is 1 point assuming that XK=1. In this case, ITF and Interleaved 2 of 5 have same priority (2 points); however, if user information is set to give the priority to the specification that is standardized by JIS, ITF will be given priority. The priority level of barcode specifications by the barcode inference of barcode is in the sequence of JAN (standard), JAN (shortened), UPC, ITF, Interleaved 2 of 5 and Code 39.

As another example, assume that in FIG. 5, the number of maximum values is 2. In FIG. 6, the number of maximum value is 1 at the upper side and 2 at the lower side. In FIG. 7, characters are numeric. In FIG. 8, number of bars in the barcode is multiple of 5. In these cases, JAN (standard) is 2 points, JAN (shortened) is 1 points, UPC is 2 points, ITF is 4 points, Interleaved 2 of 5 is 4 points, Code 39 is 3 point and NW7 is 2 points, assuming that XK=1. In this case, JAN (standard), UPC and NW7 have the same priority (2 points); however, if user information is set to give the priority to the decision by the processing in FIG. 6, NW7 will have priority. Further, if JIS standard specification is set to have priority, JAN (standard) will have priority between JAN (standard) and UPC. As the result, the priority level of barcode specifications by the barcode inference of barcode is in the sequence of ITF, Interleaved 2 of 5, Code 39, NW7, JAN (standard), UPC and JAN(shortened).

In case the total sum of the similarity of barcode stripes by the processing of the decision of the similarity of barcode stripes of FIG. 5 to FIG. 8 is not less than 50% and the result of barcode inference is narrowed down (for all processing, only one barcode specification flag is activated), it is processed at one specification candidate 96. In this case, the data is decoded with the inferred specification and each decoded result is output as recognition result 98.

Decoding with all specifications 92, decoding with multiple extracted specifications 95, and decoding with extracted specification 97 are the processing for decoding barcodes. The decoding with all specifications 92 is to decode barcodes with all the specifications that barcode recognition processing supports, the decoding with multiple extracted specifications 95 is to decode barcodes with multiple specifications extracted at barcode decision and the decoding with extracted specification 97 is to decode barcode with a specification that is specified by barcode decision processing. In decoding, at first, the specification of start and end of the specification is confirmed. If it cannot be confirmed, confirmation of the start and the end is performed rotating the barcode by 180 degrees as there is a possibility of the bar code having been rotated by 180 degrees. If it still cannot be confirmed, it is output as unreadable. The confirmation of the start and the end of the barcodes is that the data conforms the pattern of the start and the end specified by barcode specification. As the direction of barcode is decided by barcode area extraction as horizontally printed barcode or vertically printed barcode, if a barcode is a vertical barcode, the barcode is decoded rotating by 90 degrees. In decoding with multiple specifications, the decoding process is repeated according to each specification.

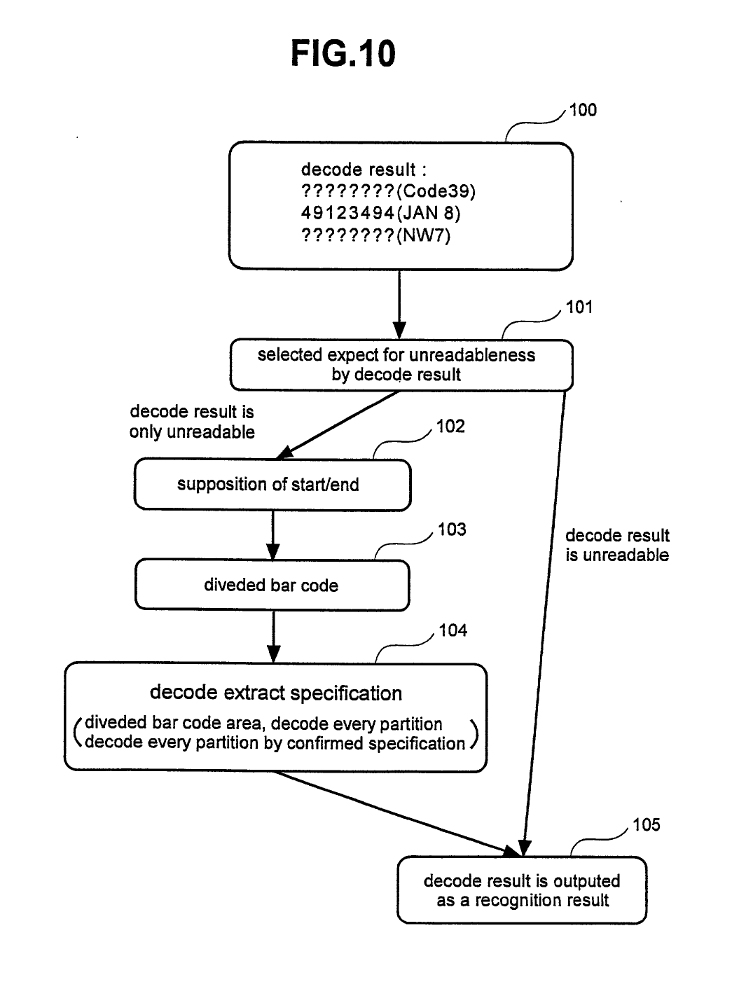

FIG. 10 is a diagram that illustrates the processing of the decision of the recognition result 15. When barcodes are decoded with multiple specifications in the processing of recognizing barcode, the recognition result is extracted from decoded results.

For example, decoded results other than unreadable are selected from the decoded results at 101 based on the decoded results as shown by 100. When some of the decoded results are readable, the decoded results are output as the recognition result.

When all of the decoded results are unreadable, supposition of start/end 102 processing is performed. In this processing, the code specifications at the start part and the end part of bar are confirmed. The confirmation is performed with all specifications of multiple specifications used for decoding. As a result, if the specifications for the start part and the end part are different, the end part in the barcode specification of the start part is sought from the next bar of the start part. Regarding to the end part, the start part in the bar code specification of the end part is sought from the previous bar of the end. In case that the end part corresponding to the start part, or the start part corresponding to the end part can be detected, the barcode image is divided up to the positions the start/end specification conforms based on the seek result (divided barcode 103). Each of the partition of barcode divided with barcode specification detected is decoded at the decode extract specification 104.

At selection of decoded result 101, in case the number of readable is multiple, narrowing down of the readable is performed. When the number of the readable is narrowed down to several specifications by the decision of the similarity of barcode stripes, the result with the barcode specification of first priority is selected. Further, in case it is unreadable with the barcode specification of the first priority, the specification of next priority is used. Otherwise, when it is unreadable with the barcode specification of the first priority, the barcodes may be left unreadable or a space may be output. Above mentioned switching of output is performed by user's instruction information. Outputting of unreadable is with the designated character code (for example, “?”) meaning unreadable and the outputting of the space is with character code of a space. When the decision of the similarity of barcode stripes decides the barcode as indefinite, unreadable or space is output (105).

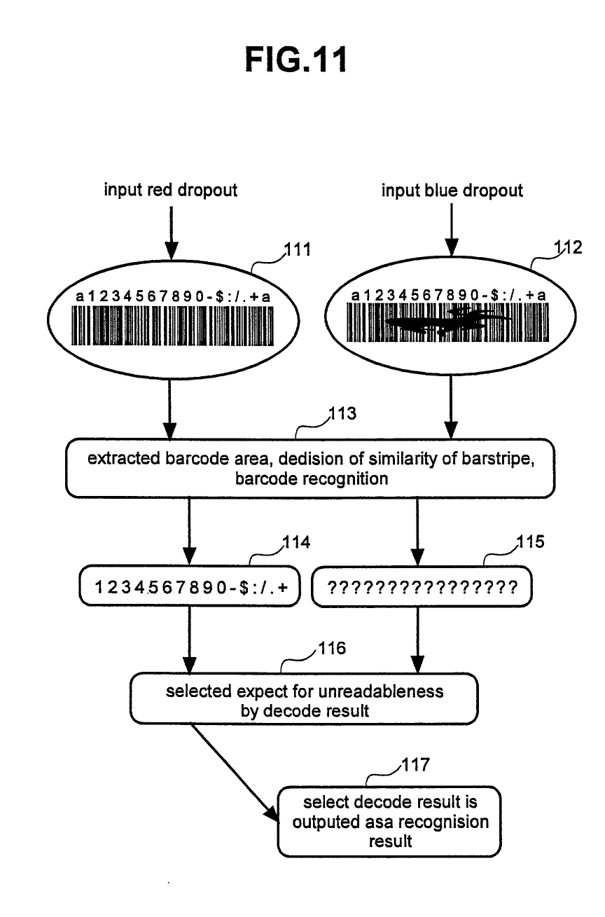

FIG. 11 is a diagram that shows the read processing of barcode with marks inside a barcode area. Here, the reading of barcodes having marks of (6) on input sheets 10 is described. In this embodiment, it is assumed that the color of mark is red or blue that can be dropped out. In reading barcode with marks, the image 111 that input the input sheets 10 with red dropout color is input and the image 112 that input the input sheets 10 with blue dropout color is input. The input images are processed with barcode area extraction, the decision of the similarity of barcode stripes, and the barcode recognition (113) as with normal barcodes. These processing are by the above mentioned processing of the present invention. Decoding result 114 of the barcode of the image of red dropout color and the decoding result 115 of the barcode of the image of blue dropout color are processed to select the result other than unreadable from the decoded result (116). Therefore, decoded result 114 that is not unreadable is selected as the recognition result and is output 117.

Following is the detailed description of a structure of a barcode reading system of an embodiment of the present invention.

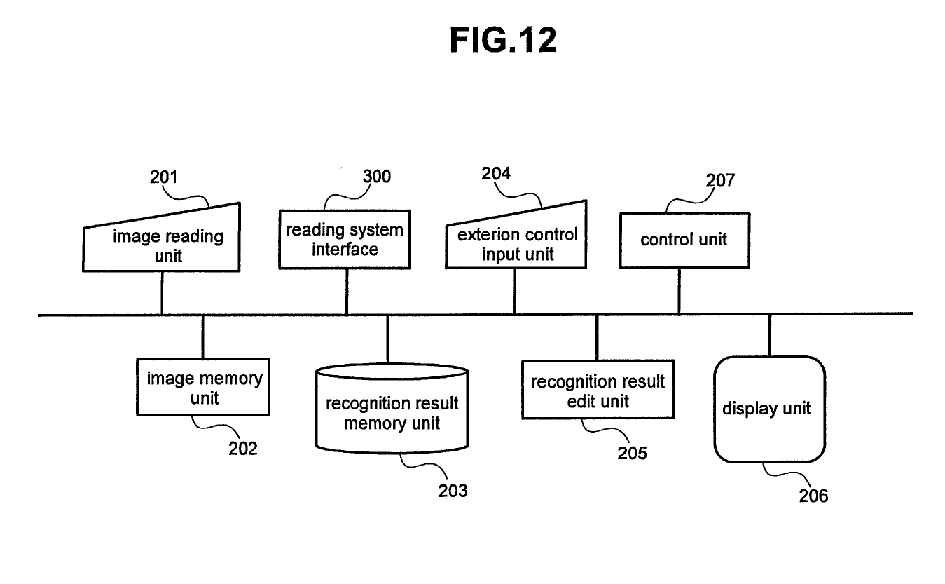

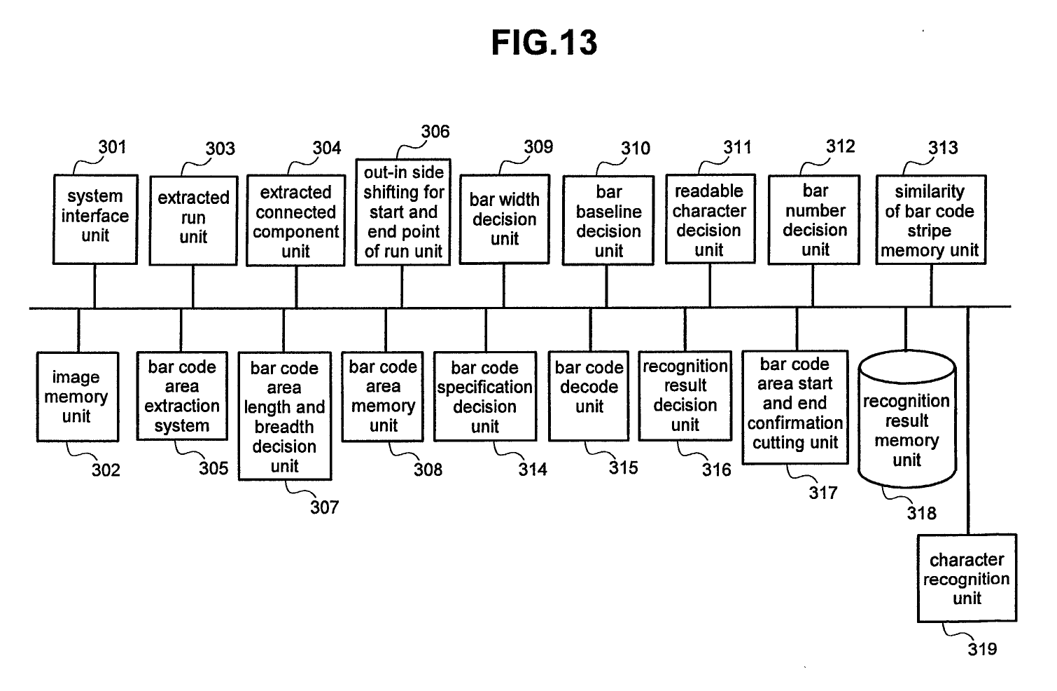

FIGS. 12 and 13 are diagrams that show the system structure of the present invention. This system comprises a system and a reading system.

FIG. 12 is a diagram that shows the structure of a system. The system consists of an image scanner unit 201 that inputs documents or input sheets as image data, an image memory unit 202 that memorizes the input image, a reading system interface 300 for calling the reading system, a recognition result memory unit 203 that stores the recognized result, an exterior control input unit 204 that inputs an instruction from a user, an image processing unit 205 that processes the input image, a display unit 206 that displays an operating screen for inputting the instruction from a user, and a control unit 207 that controls these units.

FIG. 13 is a diagram that shows the structure of reading system. The reading system consists of a system interface unit 301 that transfers control information and data to a host system (a user system), an image memory unit 302 that stores transferred images, a run extracting unit 303 that extracts run data from the image data, a connected component extracting unit 304 that extracts connected components, a barcode area extraction system 305 that extracts a barcode area, a cut-in side shifting for start and end of run unit 306 that cut-in side shift for start and end of the run, a lengthwise or breadthwise barcode area decision unit 307 that decides the direction of barcode either vertical or horizontal, a barcode area memory unit 308 that stores the barcode area information, a bar width decision unit 309 that decides the similarity of barcode stripes with bar width, a bar baseline decision unit 310 that decides the similarity of barcode stripes with a bar baseline, a readable character decision unit 311 that decides the similarity of barcode stripes with readable characters, a number of bar decision unit 312 that decides the similarity of barcodes stripes with the number of bars, a similarity of barcode stripes memory unit 313 that stores the information of the similarity of barcode stripes, a barcode specification decision unit that analyzes the specification for an adequacy of decoding, a barcode decoding unit 315 that decodes the barcodes (recognized character codes), a recognition result decision unit 316 that decides the correct recognition result of barcodes read from the decoded result, a barcode area start end confirmation cutting unit 317 that cuts off the barcode area confirming the barcode start end part, a recognition result memory unit 318 that stores the recognition result, and a character recognition unit 319.

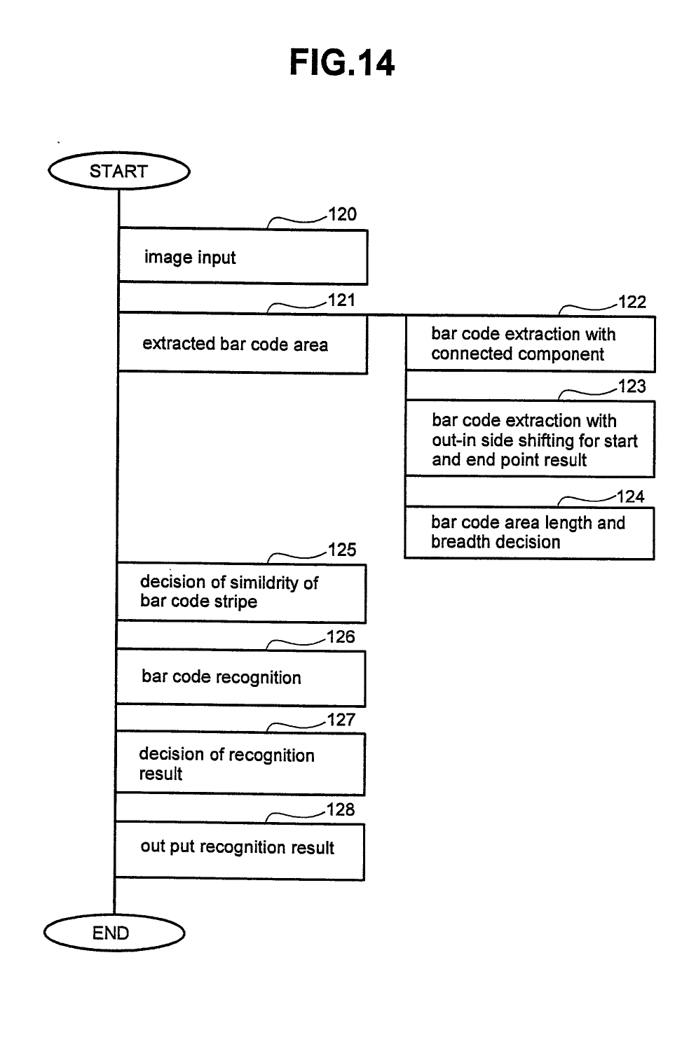

Next, in FIG. 14, a flow chart that illustrates the reading of barcodes is explained using FIG. 1, FIG. 2, FIG. 3, FIG. 4, FIG. 5, FIG. 6, FIG. 7, FIG. 8, FIG. 10, FIG. 11, FIG. 12, and FIG. 13.

First, in image input 120 of FIG. 14, the image data of input sheets 10 is input from the image reading unit 201 and the image data is stored in the image memory unit 202. Then, the image data is stored in the image memory unit 302 through the reading system interface 300 and the system interface 301.

In the barcode area extraction 121, a barcode area is extracted from the image data that is in the image memory unit 302. In the barcode area extraction, there is an extracting method with a connected component and an extracting method with cut-in side shifting for start and end point of run. The connected component is an area where black pixels are collected together and a run is whole pixels of a start and end coordinates information, of which black pixels are lined continuously on each line.

First, the method of extracting a barcode area with the connected component is explained. In the barcode area extraction with a connected component 122, a run is obtained by the run extracting unit 303 from the image data stored in the image memory unit 302 and the connected component is obtained from the run by the connected component extracting unit 304. The processing of FIG. 2 is performed by the barcode area extraction unit 305 and a bar code area is extracted from the connected component.

Then, the method of extracting a barcode area by the cut-in side shifting for start and end point of run is explained. In the barcode area extraction with cut-in sideshifting for start and end point result 123, the run is obtained by the run extracting unit 303 from the image data stored in the image memory unit 302 and processed a with the cut-in side shifting for start and end point of run unit 306. The connected component is obtained from the run with the connected component extracting unit 304. The result is processed with the processing of FIG. 3 and FIG. 4 by the barcode area extraction unit 305 and a barcode area is extracted.

Next, in the barcode area length and width decision 124, the result from the barcode area extraction unit 305 is decided by the length and/or width barcode area decision unit 307. The deciding method is that the processing result of 21 to 23 of FIG. 2 is a horizontal barcode area. The processing result of 24 to 26 corresponds to a vertical barcode area. The processing result in FIG. 3 corresponds to a horizontal barcode area. The processing result in FIG. 4 corresponds to a vertical barcode area. Then, these are stored in the barcode area memory unit 308. Selection among the methods that are extraction with the connected component, the extraction by the cut-in side shifting for start and end point of run, and the use of both is determined by user instruction.

In the decision of the similarity of barcode stripes 125, the similarity of barcode stripes in the barcode area in the barcode area memory unit 308 is decided. The processing of FIG. 5 is performed by the bar width decision unit 309, the processing of FIG. 6 is performed by the bar baseline decision unit 310, the processing of FIG. 7 is performed by the readable character decision unit 311 to extract readable characters, and the recognition result is obtained by the character recognition of the readable characters performed by the character recognition unit 319. The processing of FIG. 8 is performed by the number of bar decision unit 312. The similarity of barcode stripes and the inferred barcode obtained as the result are stored in the similarity of barcode stripes memory unit 313. This processing can be skipped according to the instruction of the user. In this case, the similarity of barcode stripes information is set to 50% for the similarity of barcode stripes and to the indefinite (cannot be pinpointed) for the barcode inference.

In the barcode recognition 126, the image inside the barcode area that is in the barcode area memory unit 308 is input from the image memory unit 302. Start and end of barcodes are confirmed before decoding by the barcode specification decision unit 314 based on the similarity of barcode stripes and the barcode inference from the similarity of barcode stripes memory unit 313. The processing 92, 93, 95 and 97 of FIG. 9 are performed by the barcode decoding unit 315. The processing 98 of FIG. 9 memorizes the decoded result into the recognition result memory unit 318. When there are readable data in multiple specifications, the recognition result decision unit 316 narrows down the readable data as described by FIG. 10.

The decision of recognition result 127 processes the decoded result of the barcode decoding unit 315 as is described by FIG. 10 by the recognition result decision unit 316 and the barcode area start end confirmation cutting unit 317. The barcodes that are cut off by the barcode area start end confirmation cutting unit 317 are decoded by the barcode decoding unit 315. The processing of 104 of FIG. 10 is to store the decoded result in the recognition result memory unit 318.

In the reading result output 128, the barcode recognition information that is stored by the recognition result memory unit 318 is stored in the reading result memory unit 203 from the reading system interface 300 through the system interface unit 301.

As for the processing of FIG. 11, the red drop out color input image 111 and the blue drop out color image 112 are input from the image reading unit 201 by the instruction of a user and are stored in the image memory unit 302. The barcode area extraction and the decision of the similarity of barcode stripes are performed on both images and decoded. The decision processing 116 that is to decide which image result to output is performed by the recognition result decision unit 316 and the output is stored in the recognition result memory unit 318. The barcode recognition information stored in the recognition result memory unit 318 is stored in the reading result memory unit 203 from the reading system interface 300 through the system interface unit 301.

When the input image is with multi-value, a multi-value image is stored in the image memory unit 302 with binary coded image by slicing it with multiple slice levels. Binary coding of image by slicing with multiple slice levels is done by the image memory processing unit 206. Succeeding process up to recognition is enabled by replacing the 2 images in the processing of FIG. 11 with multiple images. A binary coded image with multiple slice levels is, for example, three kinds of low slice level, standard slice level and high slice level. When multi-value slice levels is 256, the low slice level is 140, the standard slice level is 128, and the high slice level is 110.

When the input image is color, the color image is stored in the image memory unit 302 with binary coded image with multiple slice levels for colors. The image memory processing unit 206 performs binary coding of color image with multiple slice levels. Succeeding processing up to recognition is enabled by replacing 2 images in the processing of FIG. 11 with multiple images. For multiple binary coded color image with multiple slice levels, for example, there are three kinds of blue with standard slice level, red with standard slice level and green with standard level.

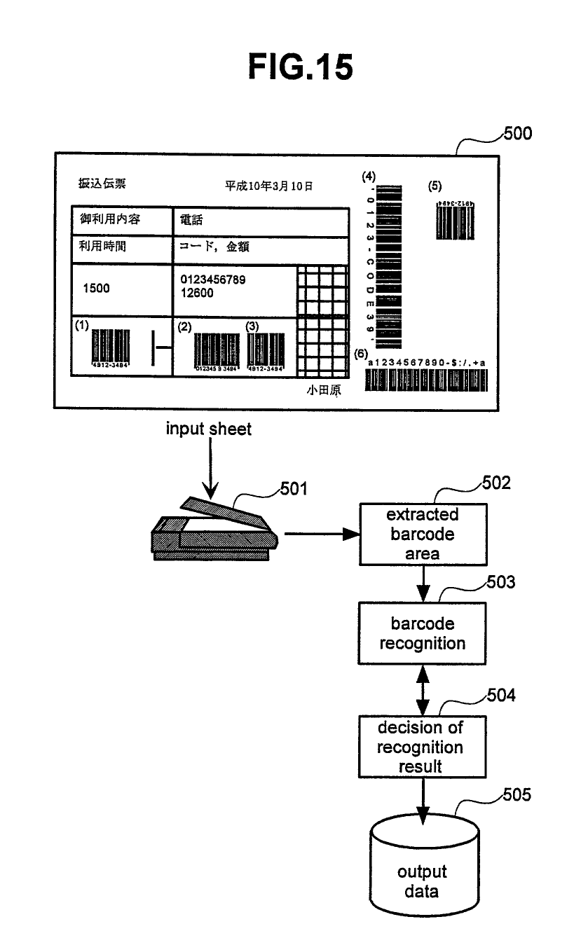

FIG. 15 is a block diagram that shows the reading of bar codes of another embodiment of the present invention. In this embodiment, the decision of the similarity of barcode stripes is not performed, but recognition of barcodes extracted by the barcode area extraction is performed with all specifications that are supported by barcode recognition. An input sheet 500 is an example barcode sheet to be read with this embodiment.

First, the barcode area extraction 502 is applied to an input sheet 500 that is input by an image scanner 501. As the barcode area extraction 502 extracts barcode area automatically from the image data on the input sheets, even the multiple barcodes are printed at different printing positions, with multiple specifications, and in different directions on each sheet, the barcode area extraction processing by the decision of connected component of FIG. 2, and the barcode area extraction processing with the cut-in side shifting for start and end point result of FIG. 3 and FIG. 4 are performed. As the same with the case of the previous embodiment, the barcodes areas printed horizontally and vertically are extracted.

A barcode recognition 503 recognizes the barcodes of an extracted barcode area. The decision of recognition result 504 decides that the barcodes are recognized and outputs the decoded result to the output data 505.

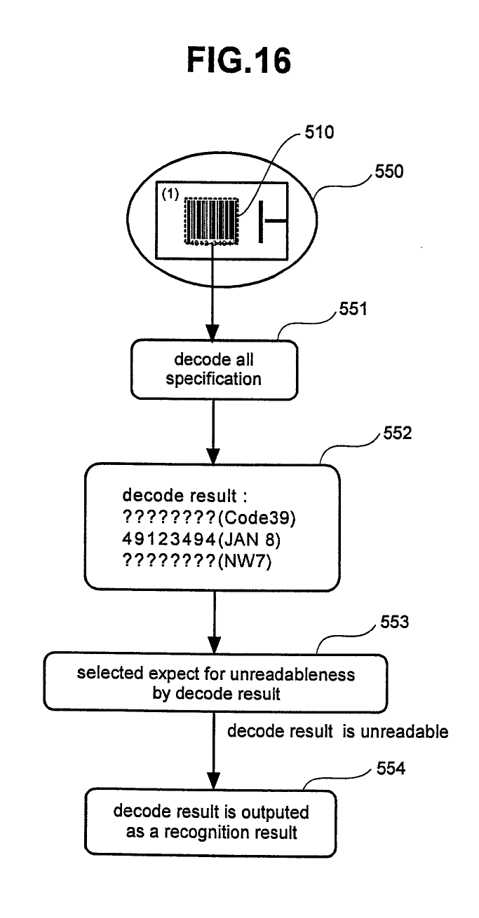

FIG. 16 is a diagram that illustrates the processing of the barcode recognition and the decision of recognition result. At 550, a barcode area 510, that is extracted by the barcode area selection 512, is selected and recognized with all the decoding specifications that the barcode recognition processing supports (step 550). The result except the unreadable is selected from the decoded result 552 (step 553). If there is any readable in the decoded result, the decoded result is output as recognized result (step 554).

In this embodiment, as the barcode recognition is performed after the extraction of a barcode area without the decision of the similarity of barcode stripes, in case the supported specifications for the barcode recognition is fewer, the barcode recognition for the input sheets, on which barcodes of multiple specifications are printed, can be performed with a simplified system.

As mentioned above, embodiments of the present invention enable the processing of the barcode area extraction, the decision of the similarity of barcode stripes, the barcode recognition and the decision of barcode recognition result. With this, the extraction of barcode areas and the barcode recognition are enabled even in case multiple barcodes of multiple specifications are printed on the input sheets at different positions and in different directions, and the extraction of barcode area and the barcode recognition are enabled even in case the barcodes of different specifications are printed at different positions and in different directions on each sheet.

The preceding has been a description of some of the embodiments of the present invention. It will be appreciated that deviations and modifications can be made without departing from the scope of the invention, which is defined by the appended claims.

What is claimed is:

1. A barcode reading system that comprises:
an image input unit that inputs sheets having multiple barcodes as binary coded image;
a barcode area extraction unit that extracts each barcode area from said multiple barcodes of said binary coded image;
a barcode recognition unit that transfers said barcodes of said multiple barcode areas to code data recognizing them with multiple barcode specifications; and
a recognition result decision unit that decides the correctness of transfer to code data as the result of recognition by said barcode recognition unit.

2. A barcode reading system as claimed in claim 1, in which said barcode area extraction unit is operatively disposed to;
extracting a connected component from said binary coded image;
deciding if a ratio between a height and a width of said connected component is not less than a first predetermined value and the width is not more than a second predetermined value;
determining if distances between said multiple connected components are not more than a predetermined length; and
extracting an area of said multiple connected components as a barcode area when the distances between said multiple connected components, of which ratio between the height and the width is not less than said first predetermined value, the width is not more than said second predetermined value, and said distances are not more than said predetermined length.

3. A barcode reading system as claimed in claim 1, in which said multiple barcodes are barcodes of different specifications.

4. A barcode reading system that comprises:
an image input unit that inputs input sheets having multiple barcodes as binary coded image;
a barcode area extraction unit that extracts each barcode area from said multiple barcodes of said binary coded image;
a decision of a similarity of barcode stripes unit that decides a specification of barcode of said multiple barcode areas;
a barcode recognition unit that recognizes a barcode of said multiple barcode areas based on a decision result and transfers the barcode to code data; and
a recognition result decision unit that decides the transfer of the barcode to code data is correct as a result of recognition by said barcode recognition unit.

5. A barcode reading system as claimed in claim 4, in which said barcode area extraction unit comprises a unit disposed operatively to:
extracting a connected components from said binary coded image;
deciding the ratio between a height and a width of said connected component is not less than a first predetermined value and the width is not more than a second predetermined value;
deciding distances between the connected components are not more than a predetermined length; and
extracting an area of said connected components as a barcode area when the distances between said connected components, of which the ratio between the height and the width is not less than the first predetermined value and the width is not more than the second predetermined value.

6. A barcode reading system as claimed in claim 4, in which said decision of the similarity of barcode stripes unit comprises:
a detection unit that detects the width of bar component on a line inside said barcode area and obtains a frequency of detected bar width as a condition of bar width; and
a decision unit that decides the existence of a maximum value with said frequency when said frequency exceeds a predetermined value, that decides binary coded image inside said barcode area as barcodes when a total of said frequencies within the predetermined range from said maximum value is not less than a predetermined value of total frequencies, and that decides a barcode specification based on a number of maximum values.

7. A barcode reading system as claimed in claim 4, in which said decision of the similarity of barcode stripes unit is operatively disposed to:
obtaining a condition of bar baseline that indicates a frequency of position of y-coordinates on a upper side of bar and a frequency of a position of y-coordinates on a lower side of bar inside said bar code area;
deciding when a binary coded image inside said barcode area is of barcodes when a total of frequencies within the predetermined range from the maximum value of said frequency is not less than the predetermined value of total frequencies, and
deciding the specification of barcode based on a number of maximum values of a frequency of a positions of said upper side and a number of maximum values of a frequency of the positions of said lower side.

8. A barcode reading system as claimed in claim 4, in which said decision of the similarity of barcode stripes unit that decides the specification of a bar code is based on a number of bars inside said barcode area.

9. A barcode reading system as claimed in claim 4, in which said decision of the similarity of barcode stripes unit extracts readable characters inside said barcode area and decides a specification of barcode based on kinds of characters recognizing said readable characters.

10. A barcode reading system as claimed in claim 4, in which said barcode recognizing unit decodes said bar code with corresponding specification when the barcode specifications inside said barcode area is pinpointed to one by said decision of the similarity of barcode stripes unit, decodes said barcodes with corresponding multiple specification when candidates of barcode specification are decided to be multiple as a result of a decision of the specifications of barcodes by said decision of the similarity of barcode stripes unit, and decodes said barcodes with all specifications that said barcode recognition unit can decode when said decision of the similarity of barcode stripes unit cannot pinpoint the specification of said barcode.

11. A barcode reading system as claimed in claim 4, characterized in that said multiple barcodes are the barcodes of mutually different specifications.

12. A method of reading barcode that includes:
inputting the input sheets having multiple barcodes as the binary coded image;
extracting a connected components from said binary coded image;
deciding a ratio between a height and a width of said connected component is not less than a first predetermined value and the width is not more than a second predetermined value;
deciding the distances between said connected components are not more than a predetermined length;
extracting the area of said multiple connected components as a barcode area when the distances between said connected components, of which the ratio between the height and the width is not less than the first predetermined value and the width is not more than the second predetermined value, and said distances are not more than said predetermined length;
decoding barcodes inside said barcode area with all specifications; and
outputting decoded barcodes, as a recognition result.

13. A method of reading barcode as claimed in claim 11, characterized in that said multiple barcodes are the barcodes of mutually different specifications.

14. A method of reading a barcode that includes:
inputting the input sheets having multiple barcodes as the binary coded image;
extracting each barcode area for said multiple barcodes from said binary coded image;
deciding a barcode specification for each barcode area;
recognizing the barcodes of each barcode area based on the decision result and transfering the barcodes to code data; and
outputting the decoded codes as a recognition result when said barcodes can be decoded.

15. A method of reading barcode as claimed in claim 14, wherein extracting each barcode for said multiple barcodes from said binary coded image comprises:
extracting a connected component from said binary coded image;
deciding the ratio between a height and a width of said connected component is not less than a first predetermined value and the width is not more than a second predetermined value;
deciding the distances between said connected components are not more than a predetermined length; and
extracting the area of said multiple connected components as the barcode area when the distances between said multiple connected components, of which ratio between the height and width is not less than the first predetermined value and the width is not more than the second predetermined value.

16. A method of reading barcode as claimed in claim 14, wherein deciding the barcode specification of each barcode area of claim 14 comprises:
detecting a width of bar component on a line inside said barcode area and obtaining a frequency of detected bar width as a condition of bar width;
deciding that there is the maximum value of said frequency when said frequency exceeds a predetermined value;
deciding that the barcode area includes the barcode when a total of said frequencies within a predetermined range from said maximum value is not less than a predetermined value of total frequency;
deciding barcode specification with a number of maximum values;
obtaining a condition of bar baseline that indicates a frequency of position on y-coordinates on a upper side and a frequency of position on y-coordinates on a lower side inside said barcode area;
deciding the barcode specification with a number of bars inside said barcode area;
extracting readable characters inside said barcode area; and
deciding barcode specifications based on the kinds of characters recognizing readable characters.

17. A method of reading barcode as claimed in claim 14, wherein recognizing the barcodes inside said barcode area based on the decision result and transferring the barcodes to code data comprising:
decoding said barcode with corresponding specification when the specification of said barcode is pinpointed to one;
decoding said barcode with some specifications when there are multiple candidates of some specifications; and
decoding said barcode with all specifications that said barcode recognition unit can decode when said barcode specifications cannot be pinpointed.

18. A method of reading barcode as claimed in claim 14, in which said multiple barcodes are barcodes of mutually different specifications.

19. A method of recognizing a barcode belonging to one of a plurality of specifications, wherein initially which specification of said plurality of specifications said barcode belongs to has not been determined, comprising:
inputting an image, comprising a barcode;
extracting a barcode area, comprising said barcode, using connected components;
determining features related to said barcode area;
using said features to determine a specification of a plurality of specifications that said barcode belongs to; and
decoding said barcode using said specification.

20. The method of claim 19 wherein said features include a frequency distribution of barcode bar widths in said barcode area.

21. The method of claim 19 wherein said bar code area includes a vertically oriented barcode.
